(19) United States
(12) Patent Application Publication
(10) Pub. No.: US 2011/0123291 A1
(43) Pub. Date: May 26, 2011

(54) ANCHOR BOLT ASSEMBLY

(76) Inventor: Ming-Chung CHIU, Keelung City (TW)

(21) Appl. No.: 12/625,175

(22) Filed: Nov. 24, 2009

(51) Int. Cl. F16B 21/00

(52) U.S. Cl. 411/342

(57) ABSTRACT

An anchor bolt assembly includes a sleeve affixed to a first plate member and having a locating groove extending around the inside wall thereof, a retaining member having a shank and a head provided with a retaining ring and movable in and out of the sleeve, a spring member adapted for forcing the retaining member out of the sleeve to a locking position to lock a second plate member to the first plate member and a pull cap connected to the distal end of the shank for pulling by the user to move the retaining member away from the locking position to an unlocking position where the second plate member is unlocked from the first plate member and the retaining ring is engaged with the locating groove to hold the retaining member in the unlocking position.

### BACKGROUND OF THE INVENTION

1. Field of the Invention

The present invention relates to anchor bolt technology and more particularly, to an anchor bolt assembly, which uses a spring member to support a retaining member in a locking position and provides a pull cap for pulling by the user to move the retaining member from the locking position to an unlocking position where a positioning means at the retaining member is engaged with a locating means inside the sleeve to keep the retaining member in the unlocking position.

2. Description of the Related Art

Screws or pins are commonly used many different products for the positioning of movable members. For example, a lock pin may be used to lock a sliding box or board member when the sliding rails of the sliding box or board member are moved relative to respective sliding grooves to a predetermined position. In a desk computer system, industrial computer system, work station or any other equipment where movable plate members are detachably arranged together, screws or pins may also be used to lock the movable plate members together, facilitating mounting and dismounting.

However, when a user touches the thread or pointed end of a screw or pin accidentally, the user may be injured. When removing a detachable plate member from a fixed plate member, all the mounted screws or pins must be removed from the plate members. The screws or pins, they may be lost easily after dismounted from the plate members. When one screw or pin is lost, the user may be unable to install the detachable plate member to the fixed plate member again. Further, when different sizes of screws or pins are dismounted from an equipment, they may be put together, and the user shall have to spend a lot of time in picking up the correct size of screws or pins during a re-installation. Further, mounting and dismounting a screw or pin requires the use of a hand tool. When different types or sizes of screws and/or pins are used, different hand tools shall be prepared.

Accordingly, it is desirable to provide a measure that eliminates the drawbacks of the use of screws or pins to lock plate members together.

### SUMMARY OF THE INVENTION

The present invention has been accomplished under the circumstances in view. It is one object of the present invention to provide an anchor bolt assembly, which facilitates mounting and dismounting of plate members without any tools. It is another object of the present invention to provide an anchor bolt assembly, which prevents falling of the dismounted plate member.

To achieve these and other objects of the present invention, an anchor bolt assembly comprises a sleeve affixed to a mounting through hole of a first plate member, a retaining member mounted in the sleeve and movable out of the sleeve to engage into a locating hole on a second plate member to lock the second plate member to the first plate member, a spring member mounted in the sleeve and adapted to force the retaining member out of the sleeve to the locking position, and a pull cap fastened to one end of the retaining member outside the sleeve for pulling by the user to move the retaining member from the locking position to an unlocking position. Further, locating means and positioning means are respectively provided inside the sleeve and at the retaining member. When the retaining member is pulled by the pull cap from the locking position to the unlocking position, the positioning means is forced into engagement with the locating means, holding the retaining member in the unlocked position inside the sleeve.

### BRIEF DESCRIPTION OF THE DRAWINGS

FIG. 1 is an elevational view of an anchor bolt assembly in accordance with a first embodiment of the present invention.

FIG. 2 is an exploded view of the anchor bolt assembly in accordance with the first embodiment of the present invention.

FIG. 3 is a sectional exploded view of the anchor bolt assembly in accordance with the first embodiment of the present invention.

FIG. 4 is a sectional applied view of the first embodiment of the present invention.

FIG. 5 is an elevational applied view of the first embodiment of the present invention.

FIG. 6 corresponds to FIG. 4, showing the retaining member disengaged from the second plate member and the second plate member separated from the first plate member.

FIG. 7 is a schematic sectional applied view of an anchor bolt assembly in accordance with a second embodiment of the present invention.

### DETAILED DESCRIPTION OF THE PREFERRED EMBODIMENT

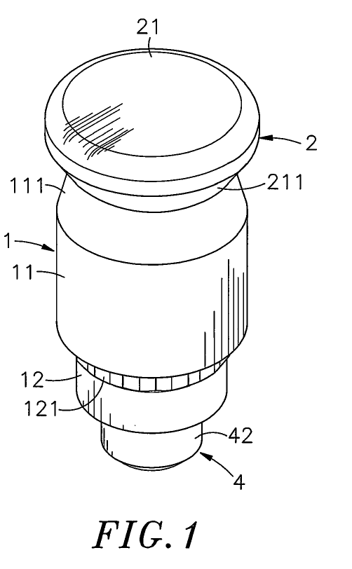

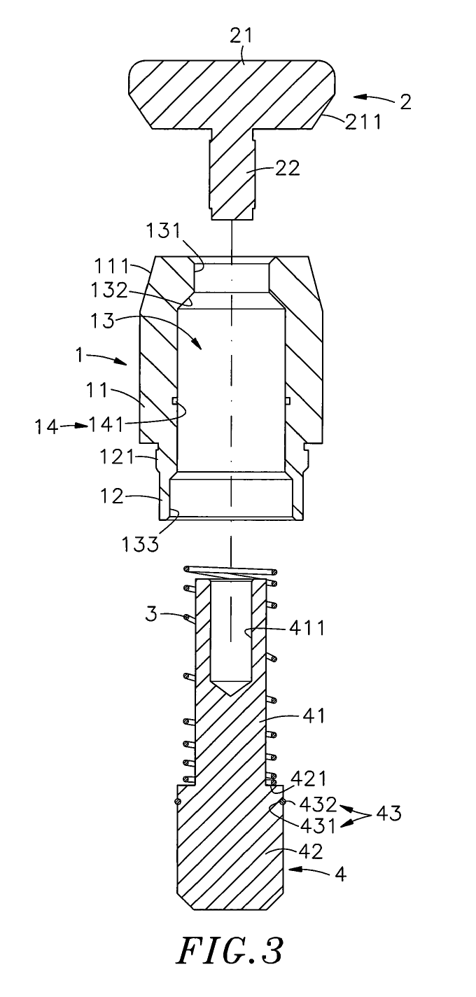

Referring to FIGS. 1-3, an anchor bolt assembly in accordance with a first embodiment of the present invention is shown comprising a sleeve 1, a pull cap 2, a spring member 3 and a retaining member 4.

The sleeve 1 comprises a tubular body 11, an anchoring portion 12 extended from one end of the tubular body 11, a plurality of locating blocks 121 arranged around the periphery of the anchoring portion 12, a chamber 13 defined in the tubular body 11, a small opening 131 formed in one end of the tubular body 11 remote from the anchoring portion 12 and disposed in communication with the chamber 13, a big opening 133 surrounded by the anchoring portion 12 and disposed in communication with the chamber 13 and in axial alignment with the small opening 131, a tapered inside wall portion 132 located on the inside between the periphery of the small opening 131 and the periphery of the chamber 13 and locating means 14 arranged around the inside wall of the chamber 13. The locating means 14 can be formed of an annular groove, an annular flange or a plurality of blocks arranged around the inside wall of the chamber 13. According to this first embodiment, the locating means 14 is a locating groove 141 extending around the inside wall of the chamber 13.

The pull cap 2 comprises a cap body 21 having a diameter greater than the sleeve 1 and adapted for stopping against one end of the sleeve 1 to block the small opening 131, and a connection rod 22 perpendicularly extended from the bottom side of the cap body 21 and insertable through the small opening 131 into the inside of the chamber 13. Further, the cap body 21 has a constricted lower section 211.

The spring member 3 is inserted through the big opening 133 into the inside of the chamber 13 and stopped with its one end against the tapered inside wall portion 132.

The retaining member 4 comprises a shank 41 inserted through the sleeve 1 in direction from the big opening 133 toward the small opening 131, a connection hole 411 axially formed in one end of the shank 41 and adapted for receiving the connection rod 22 of the pull cap 2, a retaining head 42 located on the other end of the shank 41 and having a diameter greater than the inner diameter of the small opening 131 but smaller than the inner diameter of the big opening 133 and the inner diameter of the chamber 13, a step 421 defined between the shank 41 and the retaining head 42 and adapted for supporting the other end of the spring member 3 to force the spring member 3 against the tapered inside wall portion 132 so that the head 42 is normally kept out of the big opening 133 subject to the effect of the spring power of the spring member 3 and positioning means 43 for engagement with the locating means 14 of the sleeve 1. According to this first embodiment, the positioning means 43 comprises an annular groove 431 extending around the periphery of the retaining head 42 and a retaining ring 432 mounted in the annular groove 431. The retaining ring 432 can be a rubber ring, gasket ring or metal C-ring.

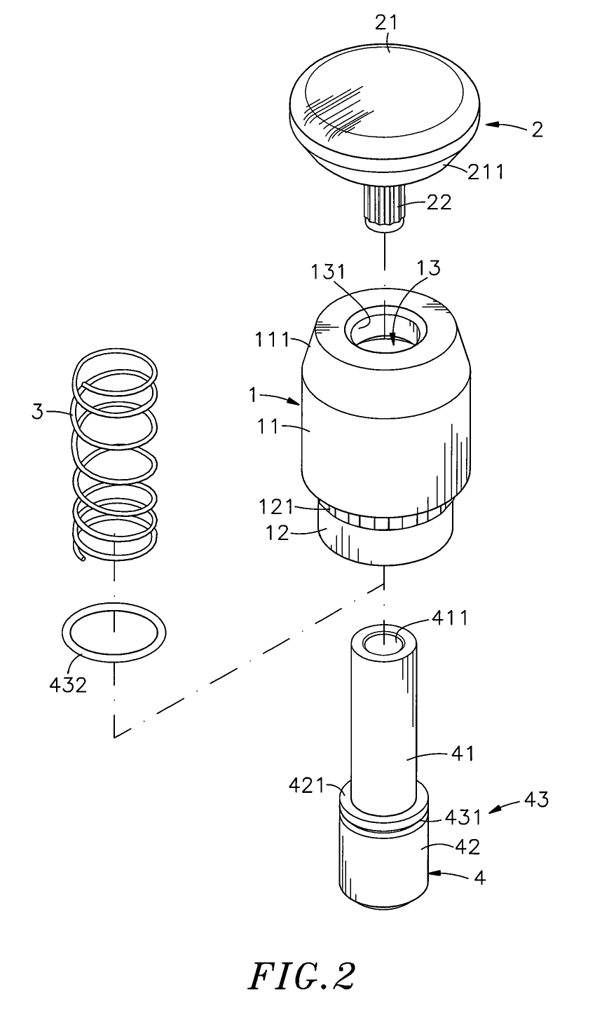

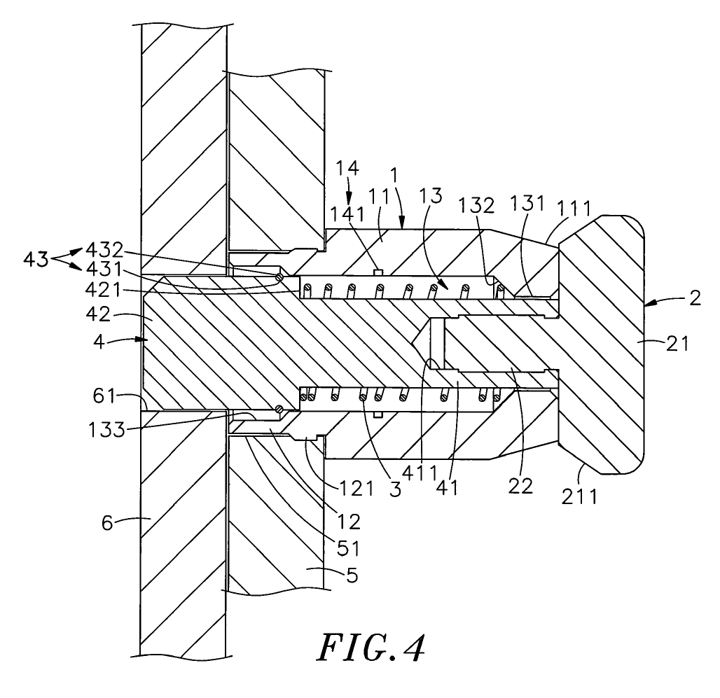

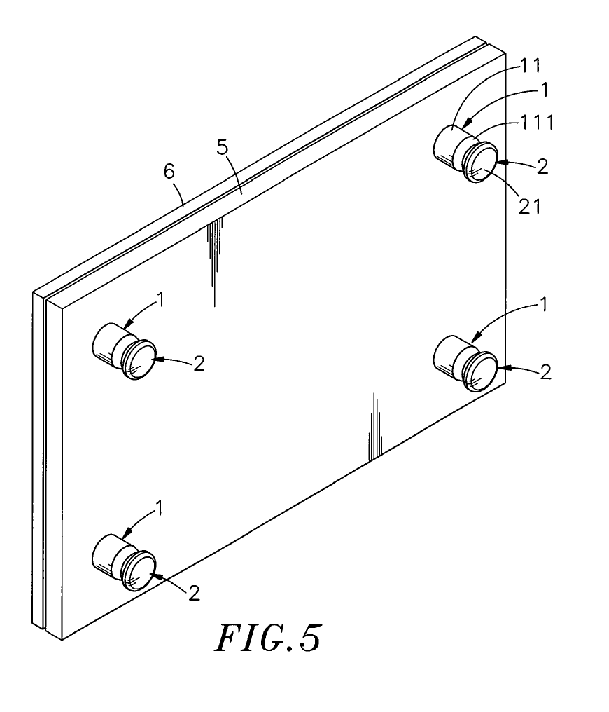

Referring to FIGS. 4 and 5 and FIGS. 2 and 3 again, the sleeve 1, the pull cap 2, the spring member 3 and the retaining member 4 are assembled before installation. During installation of the anchor bolt assembly, press-fit the anchoring portion 12 of the sleeve 1 into a mounting through hole 51 of a first plate member 5 to force the locating blocks 121 into engagement with the periphery of the mounting through hole 51 tightly. Thereafter, attach the first plate member 5 to a second plate member 6 to insert the retaining head 42 of the retaining member 4 into a locating hole 61 on the second plate member 6. In actual practice, the first plate member 5 has multiple mounting through holes 51; the second plate member 6 has multiple locating holes 61 corresponding to the mounting through holes 51 of the first plate member 5. Further, multiple anchor bolt assemblies are respectively mounted in the mounting through holes 51 of the first plate member 5 for enabling the retaining heads 42 of the retaining members 4 of the anchor bolt assemblies to be respectively fitted into the locating holes 61 of the second plate member 6 to secure the second plate member 6 to the first plate member 5.

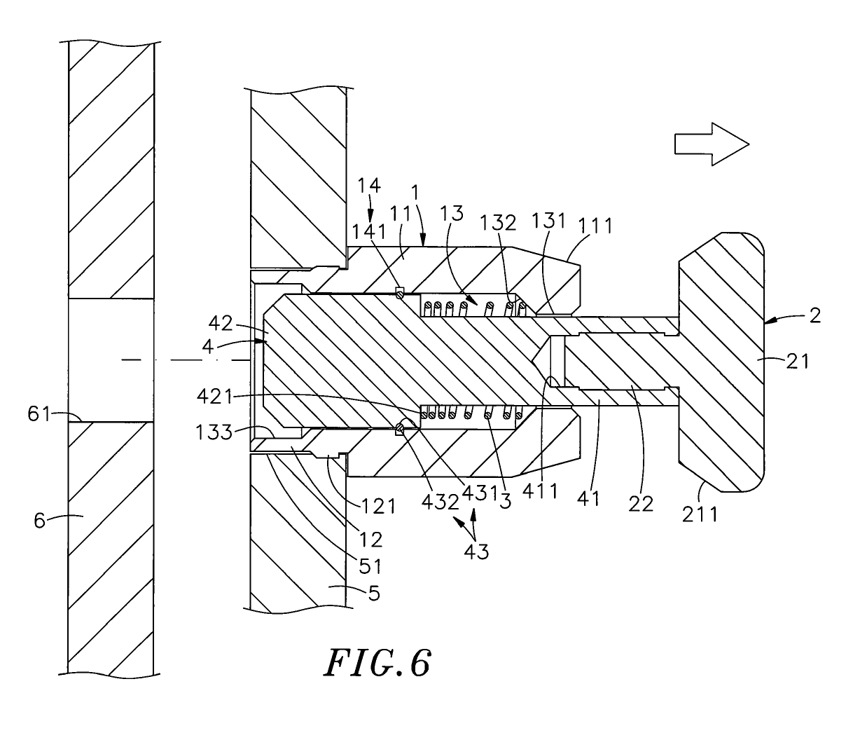

Referring to FIG. 6 and FIGS. 2-4 again, when wishing to remove the first plate member 5 from the second plate member 6, attach the fingers to the constricted lower section 211 of the pull cap 2 and then pull the pull cap 2 outwards from the small opening 131 of the sleeve 1 to carry the retaining member 4 outwards relative to the sleeve 1, thereby moving the shank 41 of the retaining member 4 out of the small opening 131 of the sleeve 1 and the retaining head 42 out of the corresponding locating hole 61 of the second plate member 6. When continuously pulling the pull cap 2 outwards at this time, the retaining ring 432 of the positioning means 43 of the retaining member 4 will be rubbed against the periphery of the chamber 13 and deformed. When the retaining ring 432 reaches the locating means 14 of the sleeve 1 during outward movement of the retaining member 4 relative to the sleeve 1, the retaining ring 432 immediately returns to its former shape and engages the locating groove 141, securing the retaining member 4 to the sleeve 1 in an unlocking position where the retaining head 42 is kept away from the corresponding locating hole 61 of the second plate member 6. Further, during movement of the retaining member 4 with the pull cap 2 relative to the sleeve 1, the step 421 of the retaining member 4 is forced against the spring member 3, thereby compressing the spring member 3. If the pulling force disappears during movement of the retaining member 4 with the pull cap 2 relative to the sleeve 1, the spring force of the spring member 3 will push the retaining member 4 backwards, thereby forcing the retaining head 42 into the corresponding locating hole 61 of the second plate member 6 again. However, when the retaining member 4 is moved away from the corresponding locating hole 61 of the second plate member 6 by the pull cap 2 to the unlocking position, the positioning means 43 of the retaining member 4 is engaged with the locating means 14 of the sleeve 1 to secure the retaining member 4 in the unlocking position positively. Thus, the user can support the first plate member 5 with one hand and operate each of the anchor bolt assemblies with the other hand to release the anchor bolt assemblies from the second plate member 6 conveniently without any tools. Therefore, releasing the anchor bolt assemblies from the second plate member 6 does not cause the first plate member 5 to fall to the ground.

Further, when securing the first plate member 5 to the second plate member 6 again, attach the first plate member 5 to the second plate member 6 to aim the mounting through holes 51 of the first plate member 5 to the respective locating holes 61 of the second plate member 6, and then move the pull cap 2 of each anchor bolt assembly in direction toward the second plate member 6 relative to the associating sleeve 1 to force the retaining ring 432 of the positioning means 43 of the retaining member 4 of each anchor bolt assembly away from the locating groove 141 of the locating means 14 of the associating sleeve 1. When the retaining ring 432 of the positioning means 43 of the retaining member 4 of each anchor bolt assembly is disengaged from the locating groove 141 of the locating means 14 of the associating sleeve 1, the spring power of the spring member 3 immediately forces the associating retaining member 4 in direction toward the second plate member 6, thereby causing the retaining head 42 to be fitted into the associating locating hole 61 of the second plate member 6. Thus, the retaining members 4 of the anchor bolt assemblies can be quickly engaged into the respective locating holes 61 of the second plate member 6 to lock the first plate member 5 to the second plate member 6.

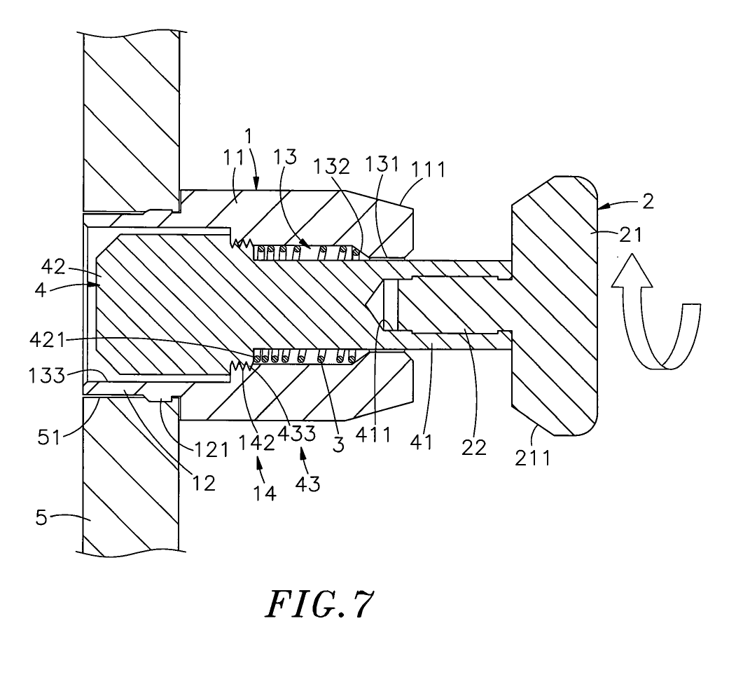

FIG. 7 illustrates an anchor bolt assembly in accordance with a second embodiment of the present invention. This second embodiment is substantially similar to the aforesaid first embodiment with the exception of the locating means 14 and the positioning means 43. According to this second embodiment, the locating means 14 is an inner thread 142 disposed inside the chamber 13 adjacent to the big opening 133; the positioning means 43 is an outer thread 433 extending around the periphery of the retaining head 42 for engagement with the inner thread 142. The outer diameter of the outer thread 433 is smaller than the inner diameter of the bit opening 133. When the user pulls the pull cap 2 outwards relative to the sleeve 1 to the position where the outer thread 433 of the retaining member 4 touches the inner thread 142 of the sleeve 1, the user can rotate the pull cap 2 to move the outer thread 433 of the retaining member 4 into engagement with the inner thread 142 of the sleeve 1. At this time, the retaining member 4 is locked to the sleeve 1 in the unlocking position, keeping the retaining head 42 inside the anchoring portion 12 of the sleeve 1. When rotating the pull cap 2 in the reversed direction to disengage the outer thread 433 of the retaining member 4 from the inner thread 142 of the sleeve 1, the spring power of the spring member 3 immediately pushes the retaining head 42 of the retaining member 4 out of the big opening 133 of the sleeve 1.

Further, the retaining head 42 does not have a pointed end. When the retaining head 42 extends out of the sleeve 1, the outer thread 433 of the retaining member 4 is kept inside the big opening 133. Therefore, if the user touches the retaining head 42 of the retaining member 4 accidentally, the retaining head 42 does not injure the user. Further, because the shank 41 of the retaining member 4 is fixedly connected to the connection rod 22 of the pull cap 2, the retaining member 4 does not fall from the anchor bolt assembly after installation of the sleeve 1 in the first plate member 5.

Further, the sleeve 1 has a tapered outer wall portion 111 extending around the small opening 131. When the pull cap 2 is abutted against the sleeve 1, a space is defined around the tapered outer wall portion 111 of the sleeve 1 and the constricted lower section 211, facilitating access of the user's hand to the constricted lower section 211 of the pull cap 2.

In conclusion, the invention provides an anchor bolt assembly in which, the pull cap 2 is provided at one side relative to the small opening 131 of the sleeve 1; the retaining member 4 is provided at the other side and inserted with the shank 41 thereof through the bit opening 133 into the chamber 13 and connected to the connection rod 22 of the pull cap 2; the spring member 3 is sleeved onto the shank 41 of the retaining member 4 and stopped between the tapered inside wall portion 132 of the sleeve 1 and the step 421 of the retaining member 4; the sleeve 14 has a locating means 14 disposed inside the chamber 13; the retaining member 4 has a positioning means 43 located on the periphery of the retaining head 42 for engagement with the locating means 14. When pulling the pull cap 2 to move the retaining member 4 backwards to the unlocking position where the retaining head 42 of the retaining member 4 is kept inside of the sleeve 1, the positioning means 43 is forced into engagement with the locating means 14, holding the retaining member 4 in the unlocking position.

A prototype of anchor bolt assembly has been constructed with the features of FIGS. 1˜7. The anchor bolt assembly functions smoothly to provide all of the features disclosed earlier.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. An anchor bolt assembly installed in a mounting through hole of a first plate member for fastening to a locating hole of a second plate member to secure said second plate member to said first plate member, the anchor bolt assembly comprising:
a sleeve, said sleeve comprising a tubular body, an anchoring portion extended from one end of said tubular body and fastened to said mounting through hole of said first plate member, a chamber defined in said tubular body, a small opening formed in one end of said tubular body remote from said anchoring portion and disposed in communication with said chamber, a big opening surrounded by said anchoring portion and disposed in communication with said chamber and in axial alignment with said small opening and locating means disposed inside said chamber;
a pull cap, said pull cap comprising a cap body adapted for abutting against one end of said small opening of said sleeve outside said sleeve;
a retaining member inserted through said sleeve and connected to said pull cap and movable by said pull cap between a locking position where said retaining member is engaged into said locating hole of said second plate member and an unlocking position where said retaining member is disengaged from said locating hole of said second plate member, said retaining member comprising a shank inserted said big opening and said chamber and connected to said cap, a retaining head located on one end of said shank remote from said pull cap and movable with said shank by said pull cap in and out of said big opening for engaging into said locating hole of said second plate member and positioning means for engagement with said locating means of said sleeve when said retaining member is pulled by said pull cap away from said locking position to said unlocking position; and
a spring member sleeved onto said shank of said retaining member and stopped between a part of said retaining member and a part of said sleeve inside said chamber adjacent to said small opening and adapted to impart a pressure to said retaining member relative to said sleeve in direction from said unlocking position toward said locking position.

2. The anchor bolt assembly as claimed in claim 1, wherein said retaining head has an outer diameter smaller than the inner diameter of said big opening and the inner diameter of said chamber and greater than the inner diameter of said small opening.

3. The anchor bolt assembly as claimed in claim 1, wherein said sleeve comprises a tapered outer wall portion extending around said small opening; said cap body of said pull cap comprises a constricted lower part for gripping by a user.

4. The anchor bolt assembly as claimed in claim 1, wherein said sleeve further comprises a plurality of locating blocks arranged around the periphery of said anchoring portion for engagement with the periphery of said mounting through hole of said first plate member tightly.

5. The anchor bolt assembly as claimed in claim 1, wherein said sleeve comprises a tapered inside wall portion defined between said small opening and said chamber for stopping against one end of said spring member.

6. The anchor bolt assembly as claimed in claim 1, wherein said locating means of said sleeve is a locating groove extending around an inside wall of said sleeve in said chamber; said positioning means of said retaining member comprises an annular groove extending around the periphery of said retaining head and a retaining ring mounted in said annular groove for engaging said locating groove of said locating means of said sleeve.

7. The anchor bolt assembly as claimed in claim 1, wherein said locating means of said sleeve is an inner thread; said positioning means of said retaining member is an outer thread for engagement with said inner thread of said locating means of said sleeve subject to a rotary motion of said retaining member.

8. The anchor bolt assembly as claimed in claim 1, wherein said retaining member comprises a connection hole axially formed in said shank; said pull cap comprises a connection rod perpendicularly extended from said cap body and fastened to said connection hole of said retaining member.

9. The anchor bolt assembly as claimed in claim 1, wherein said retaining member comprises a step defined between said shank and said retaining head for stopping against one end of said spring member.
